(19) United States
(12) Patent Application Publication
(10) Pub. No.: US 2015/0202102 A1
(43) Pub. Date: Jul. 23, 2015

(54) Wheelchair with Automatic Seat Lift Mechanism

(71) Applicant: Anita Dunham, Charlotte, NC (US)

(72) Inventor: Anita Dunham, Charlotte, NC (US)

(21) Appl. No.: 14/560,457

(22) Filed: Dec. 4, 2014

Related U.S. Application Data
(60) Provisional application No. 61/929,155, filed on Jan. 20, 2014.

(51) Int. Cl. A61G 5/10

(52) U.S. Cl. CPC A61G 5/1059; A61G 5/1056

(57) ABSTRACT

A wheelchair with an automatic seat lift mechanism is disclosed. The wheelchair includes a seat that is connected to a lift mechanism. The lift mechanism is connected to a pump that is driven by a motor, wherein the pump is an electrical pump or a hydraulic pump. In one embodiment, the motor is actuated via a hand held controller having a joystick thereon. The joystick can be used to change the height and position of the seat so as to ease the process of getting into and out of the wheelchair. When the seat is in an elevated position, the armrests of the wheelchair can be pivoted upward so that they do not interfere with the movement of the seat. The seat can be positioned adjacent to a bed or another supporting surface so that the wheelchair user can slide onto or off of the seat without being lifted.

### CROSS REFERENCE TO RELATED APPLICATION

This application claims the benefit of U.S. Provisional Application No. 61/929,155 filed on Jan. 20, 2014. The above identified patent application is herein incorporated by reference in its entirety to provide continuity of disclosure.

### FIELD OF THE INVENTION

The present invention relates to wheelchairs. More specifically, the present invention pertains to an improved wheelchair having a seat lift mechanism that is automatically actuated via a controller. In this way, the present invention increases patient safety and convenience when transporting patients.

### BACKGROUND OF THE INVENTION

Patient safety is often the main concern when moving patients from a wheelchair to a bed. Moving patients generally requires the patient's help, or assistance from other caregivers. This can be an extremely difficult and laborious process when the patient is disabled and/or too heavy to move. Improperly lifting the patients can be unsafe for the patients as well as the caregivers. For example, an improper lift can cause the patient to accidentally fall out of the wheelchair and sustain a further injury. Alternatively, the caregiver can seriously injure his or her back due to lumbar strains.

Devices have been disclosed in the prior art that claim wheelchairs having seats that can be lifted. These include devices that have been patented and published in patent application publications. Some of these devices disclose wheelchairs having seats that can pivot with respect to the seat frame. The seats are generally connected to a lever that can elevate the rear portion of the seat so as to allow the user to slide off of the seat. The lever, however, must be manually actuated, which can be impractical for many wheelchair users who may be disabled or who have poor grip strength. Additionally, the pivoting motion of the seat forces the user to stand after getting out of the wheelchair, which can be difficult to accomplish without receiving assistance from another person.

Other devices disclose wheelchairs having arm rests or side panels that can lift. In this way, the wheelchair user can slide sideways to get into or out of the wheelchair. This is particularly useful when the user is moving from the wheelchair and into another chair or a bed, or vice versa. While lifting the arm rests or side panels allows the user to slide sideways, it is still not feasible for the user to move to and from the wheelchair and another piece of furniture when the height of the seat of the wheelchair is significantly lower or higher than the chair or bed onto which the user desired to move.

The devices disclosed in the prior art have several known drawbacks. These devices are limited in that the entire seat portion of the wheelchair cannot be raised or lowered in height. Additionally, none of the prior art devices disclose wheelchair seats that can be elevated in various directions to close the gap between the wheelchair seat and another piece of furniture. The present invention overcomes these limitations by disclosing a wheelchair with an automatic seat lift mechanism. The present invention comprises a wheelchair having a seat that is connected to a lift mechanism. The lift mechanism allows the entire seat to be elevated. Additionally, the lift mechanism allows the entire seat to be moved to the left or right without moving the wheelchair. The lift mechanism is driven by a pump that is actuated via a motor that can be controlled via a joystick or a similar controlling mechanism.

The seat lift mechanism is adapted to lift the wheelchair user while he or she is sitting in the seat. Thus, one of the advantage of the present invention is that it does not require the wheelchair user to be lifted when getting into or out of the wheelchair. The controlling mechanism may be operated by the wheelchair user or by a caregiver. Additionally, the present invention may be retrofitted to existing wheelchairs or easily be manufactured. As will be described in further detail herein, there are many additional features of the instant invention.

It is therefore submitted that the present invention is substantially divergent in design elements from the prior art, and consequently it is clear that there is a need in the art for an improvement to wheelchairs having seats that can be lifted. In this regard, the instant invention substantially fulfills these needs.

### SUMMARY OF THE INVENTION

In view of the foregoing disadvantages inherent in the known types of wheelchairs now present in the prior art, the present invention provides a new and improved wheelchair with an automatic seat lift mechanism wherein the same can be utilized for helping individuals get into and out of wheelchairs.

It is therefore an object of the invention to provide a new and improved wheelchair with an automatic seat lift mechanism that has all of the advantages of the prior art and none of the disadvantages.

Another object of the present invention is to provide a new and improved wheelchair with an automatic seat lift mechanism that can be easily controlled via a joystick controller.

Yet another object of the present invention is to provide a new and improved wheelchair with an automatic seat lift mechanism that can change the height of the seat of the wheelchair without requiring assistance from another individual.

Still yet another object of the present invention is to provide a new and improved wheelchair with an automatic seat lift mechanism that can help increase mobility of the wheelchair user.

Still yet another object of the present invention is to provide a new and improved wheelchair with an automatic seat lift mechanism wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the present invention.

FIG. 2 shows a perspective view of the present invention in a raised configuration.

FIG. 3 shows another perspective view of the present invention in a raised configuration.

FIG. 4 shows a close up view of the controller of the present invention.

FIG. 5 shows an exemplary schematic diagram of the present invention.

FIG. 6 is a flow chart illustrating the control logic of the present invention.

### DETAILED DESCRIPTION OF THE INVENTION

References are made herein to the attached drawings. Like reference numerals are used throughout the drawings to depict like or similar elements of the wheelchair with an automatic seat lift mechanism. For the purposes of presenting a brief and clear description of the present invention, the preferred embodiment will be discussed as used to help individuals get into and out of wheelchairs. The figures are intended for representative purposes only and should not be considered to be limiting in any respect.

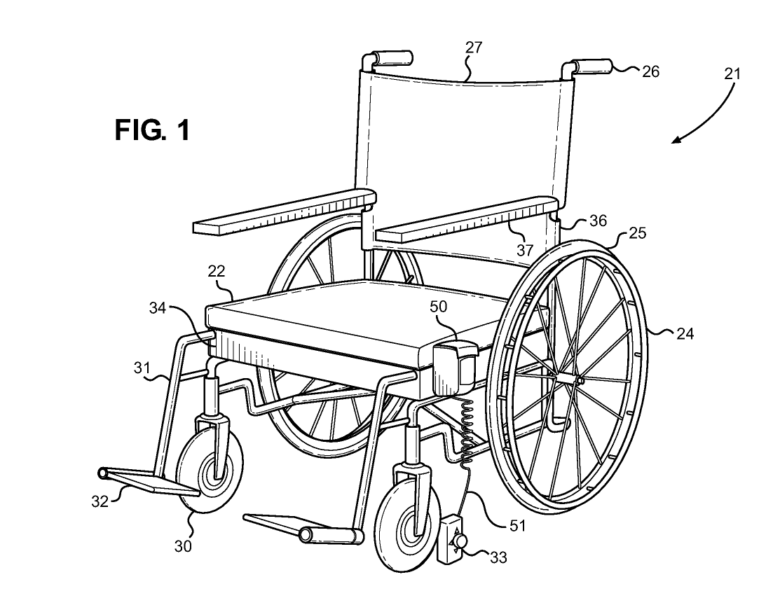

Referring now to FIG. 1, there is shown a perspective view of the present invention. The present invention comprises a wheelchair 21 having a general construction known in the art. Specifically, the wheelchair 21 comprises a horizontal seat frame that is perpendicular to a vertical back frame 36. Preferably, the seat frame is welded to the back frame 36 so that the frames are unitary in construction. The back frame 36 comprises a pair of elongated rods, each having an upper end and a lower end. The elongated rods are disposed on opposing sides of a back portion 27, which is composed of durable, padded fabric. In one embodiment, opposing sides of the back portion 27 are wrapped around the elongated rods of the back frame 36, then folded onto itself and stitched along the side thereof.

Each side of the back frame 36 comprises a hand grip 26 at an upper end thereof. The hand grips 26 are substantially perpendicular to the back frame 36 so that a caregiver or another individual can grab the hand grip 26 to propel the wheelchair in forward or backward directions. The back frame 36 further comprises a pair of armrests 37 pivotally attached thereto. In a down position, the armrests 37 are substantially parallel to the horizontal axis. In an up position, the armrests 37 are substantially parallel with the vertical axis.

The wheelchair 21 further comprises a pair of front wheels 30 and a pair of rear wheels 25. It is contemplated that the wheels comprise a locking mechanism so as to prevent the wheelchair 21 from moving when desired by the user. The front wheels 30 comprise caster wheels that are adapted to swivel so as to allow the user to change directions when utilizing the wheelchair 21. The front wheels 30 are attached to the seat frame of the wheelchair 21. The rear wheels 25 comprise a push rim 24. In some embodiments, the rear wheels 25 further comprise brakes attached thereto. The hub of the rear wheels 25 is attached to the back frames 36.

The seat frame comprises a seat support 34 having a seat 22 attached thereto. The seat support 34 is substantially rectangular and comprises a bottom wall having upstanding side walls. The seat 22 is dimensioned so that it can fit within the side walls. The seat 22 is composed of padded material to provide comfort to the user. In one embodiment, the seat 22 comprises a controller holder 50 at a side thereof. The controller holder is configured to hold a controller 33 therein, wherein the controller 33 is electrically connected to the wheelchair 21 via a cord 51. The cord 51 comprises a coiled cable so that it can be stretched across the wheelchair 21 and is therefore readily accessible to the wheelchair user or the care giver.

The seat support 34 further includes a pair of hanger bracket 31 extending downward therefrom. Each hanger brackets 31 comprises a foot rest 32 pivotally attached to at a lower end thereof. In this way, the foot rests 32 can be lifted into a vertical position, or lowered into a horizontal position. The upper surface of the foot rests 32 comprises a high friction material or treading thereon.

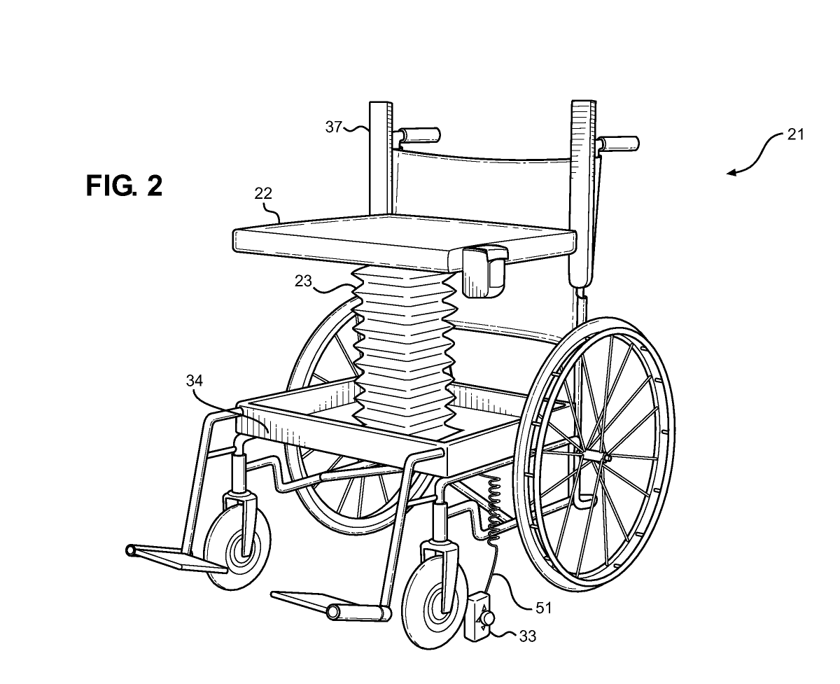

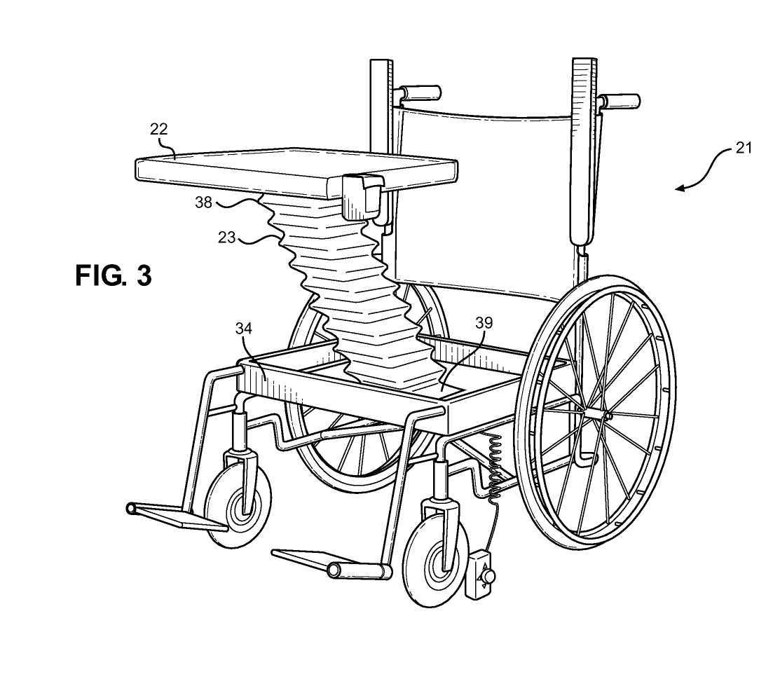

Referring now to FIGS. 2 and 3, there are shown views of the present invention in raised configurations. The height and the position of the seat 22 can be adjusted via a lift mechanism 23. The lift mechanism 23 comprises an adjustable arm having an upper end 38 and a lower end 39. In the illustrated embodiment, the adjustable arm comprises an accordion-like construction so that it can be easily retracted or extended in length. The upper end 38 of the lift mechanism 23 is connected to the underside of the seat 22. The lower end 39 of the lift mechanism 23 is connected to a pump that is disposed within the seat support 34. It is contemplated that the pump may comprise an electrical pump or a hydraulic pump, depending upon embodiment. The pump is driven by a motor that is disposed within the seat support 34. The motor is controlled via the controller 33, which is electrically connected thereto via the cord 51.

The controller 33 can be used to raise or lower the seat 22, as depicted in FIG. 2. Additionally, the controller 33 can be used to move the seat 22 to the right or to the left, as depicted in FIG. 3. It is contemplated that the wheelchair is counterbalanced to prevent the wheelchair from being tipped over when the seat 22 is elevated. When the seat 22 is elevated above the seat support 34, the armrests 37 can be raised into a vertical position so that the armrests 37 do not inhibit the movement and positioning of the seat 22. In use, the seat 22 can be positioned directly adjacent to a bed or another piece of furniture so that the wheelchair user can slide onto or off of the seat 22 without being lifted by a caregiver. In this way, the present invention increases patient safety and provides convenience to care givers.

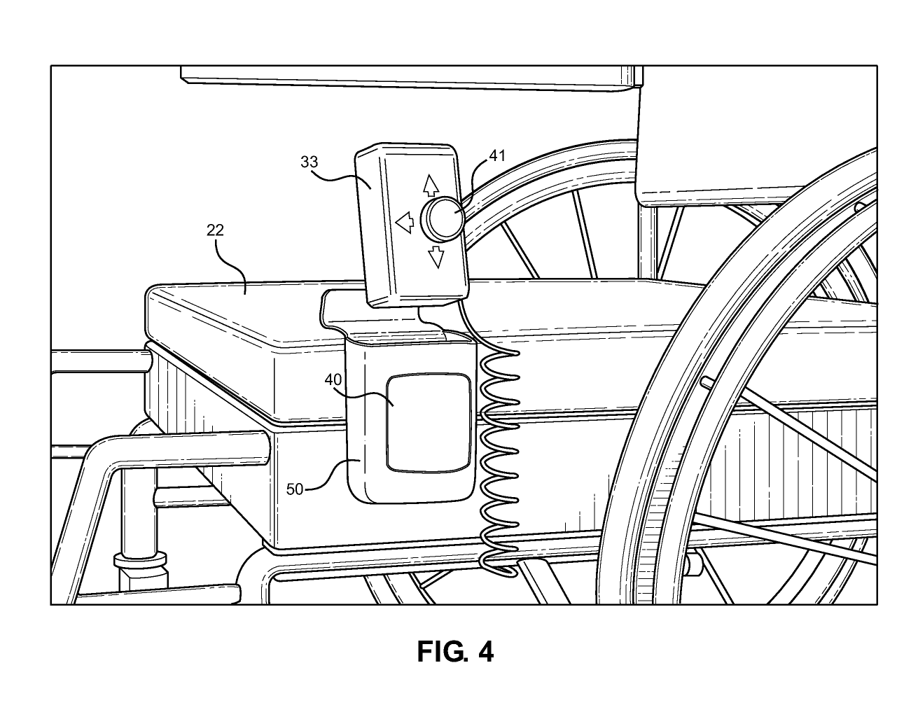

Referring now to FIG. 4, there is shown a close up view of the controller of the present invention. The controller 33 comprises a housing having a controlling mechanism. In the illustrated embodiment, the controlling mechanism comprises a joystick 41 that can be pivoted left, right, up, or down. The joystick 41 is spring loaded, so that it will return to a central position when it is released. The controller 33 is stored in a holder 50 that is mounted on the seat 22. The holder 50 comprises a bottom wall, a front wall, a back wall, and side walls, leaving the top open. In some embodiments, the top portion of the holder 50 further comprises a lid thereon. The front wall of the holder 50 comprises an opening 40 so that the joystick 41 is accessible when the controller 33 is secured within the holder 50. The back wall of the holder 50 is attached to a side of the seat 22. The holder 50 may be attached via adhesives or via fasteners such as hook and loop fasteners.

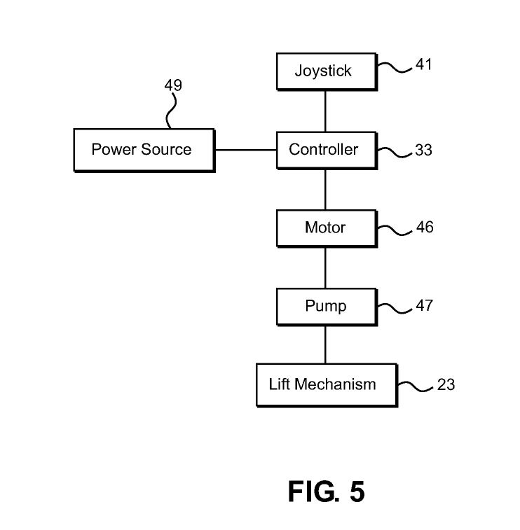

Referring now to FIG. 5, there is shown an exemplary schematic diagram of the present invention. The joystick 41 is electrically connected to the controller 33, which is powered internally via a power source 49 such as batteries. The controller 33 actuates the motor 46 to drive the pump 47, which in turn activates the lift mechanism 23. The pump 47 may comprise an electrical pump or a hydraulic pump, depending upon embodiment. The controller 33 comprises the necessary internal circuitry to operate the motor. For instance, the controller 33 comprises a microprocessor to determine the appropriate position of the seat based on the position of the joystick

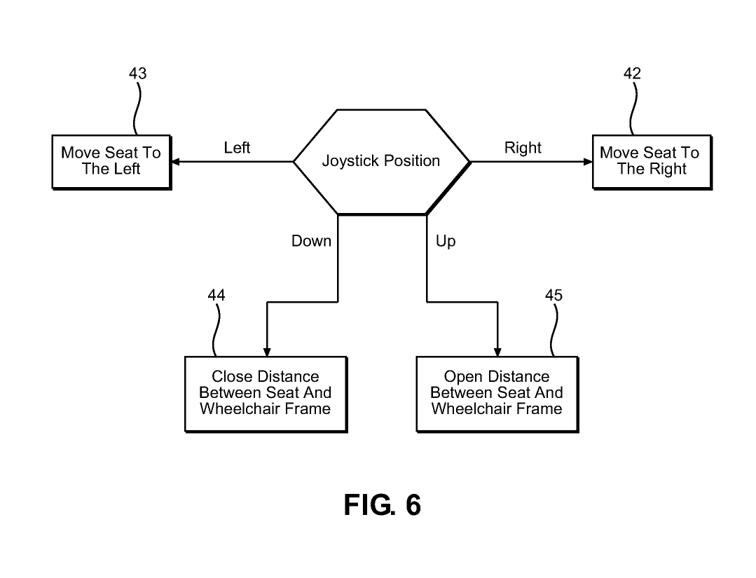

Referring now to FIG. 6, there is shown a flow chart illustrating the control logic of the present invention. The position of the joystick determines the direction of movement of the seat. For instance, when the joystick is moved to the left, the upper end of the lift mechanism moves to the left, thereby moving the seat to the left 43. Conversely, if the joy stick is moved to the right, the upper end of the lift mechanism moves to the right, moving the seat to the right 42. When the joystick is pointed down, the lift mechanism retracts, lowering the seat and decreasing the distance between the seat and the wheelchair frame 44. Conversely, when the joystick is pointed up, lift mechanism extends to raise the seat and opening the distance between the seat and the wheelchair frame 45.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A wheelchair with an automatic seat lift mechanism, comprising:
a wheelchair having a seat that is connected to a lift mechanism;
said lift mechanism actuated via a pump that is driven by a motor;
said motor controlled via a controller;
wherein said lift mechanism is adapted to vertically adjust the positioning of said seat.

2. The wheelchair of claim 1, wherein said pump comprises an electrical pump.

3. The wheelchair of claim 1, wherein said pump comprises a hydraulic pump.

4. The wheelchair of claim 1, wherein said controller comprises a joystick.

5. The wheelchair of claim 4, whereby pointing said joystick upward raises said seat by increasing a distance between said seat and said wheelchair, and pointing said joystick downward lowers said seat by decreasing said distance between said seat and said wheelchair.

6. The wheelchair of claim 4, wherein said lift mechanism is further adapted to move said seat to the left or to the right;
whereby pointing said joystick to the left moves said seat to the left and pointing said joystick to the right moves said seat to the right.

7. The wheelchair of claim 1, wherein said lift mechanism comprises an elongated arm having an upper end connected to an underside of said seat and a lower end connected to said pump.

8. The wheelchair of claim 7, wherein said elongated arm comprises an accordion-like construction.

9. The wheelchair of claim 1, further comprising a controller holder attached to said seat;
said controller holder configured to removably secure said controller therein.
